(19) United States
(12) Patent Application Publication
(10) Pub. No.: US 2023/0102756 A1
(43) Pub. Date: Mar. 30, 2023

(54) REROUTING CARD-ORIGINATED PAYMENT TRANSACTIONS FROM A DEFAULT PAYMENT CARD NETWORK WORKFLOW TO A BLOCKCHAIN SYSTEM

(71) Applicant: Marqeta, Inc., Oakland, CA (US)

(72) Inventors: Sujin Park, San Francisco, CA (US); Micah Riggan, Alpharetta, GA (US)

(21) Appl. No.: 17/487,862

(22) Filed: Sep. 28, 2021

(51) Int. Cl. G06Q 20/38; G06Q 20/34; G06Q 20/06

(52) U.S. Cl. CPC G06Q 20/389; G06Q 20/34; G06Q 20/065

(57) ABSTRACT

This disclosure describes methods, non-transitory computer readable storage media, and systems that reroute card-originated payment transactions from a default payment card network workflow to a blockchain system for blockchain enabled transactions. Specifically, in one or more embodiments, the disclosed systems receive a payment interchange message from a payment card network indicating a card-originated payment transaction initiated at a point-of-sale device of a recipient entity. The disclosed systems determine payment configurations for a recipient entity based on an entity identifier from the payment interchange message. Based on the payment configurations including blockchain settings enabling blockchain transactions, the disclosed systems reroute the card-originated payment transaction by first generating digital processing instructions for adding the card-originated payment transaction to a smart contract within the blockchain system. The disclosed systems provide the digital processing instructions to the blockchain system to add the card-originated payment transaction to the smart contract for processing the transaction.

### BACKGROUND

Payment transactions utilizing physical point-of-sale devices provide convenient and consistent methods of payment for in-store or other in-person purchases by customers and are often more prevalent than cash transactions. For example, many entities (e.g., merchants) install card readers to allow customers to swipe physical cards or utilize digital versions of their cards on mobile devices to interact with the card readers (e.g., via near-field communication) to initiate card-originated payment transactions with the entities. Payment networks then process the card-originated payment transactions via a specific payment card network workflow to transfer funds from customer accounts to entity accounts.

While such payment transactions are widely implemented for many merchants and other entities, existing payment card network workflows for processing card-originated payment transactions suffer from a number of inefficiencies. In particular, the existing systems and networks involved in processing card-originated payment transactions require specific hardware/software configurations for point-of-sale devices. Due to the cost and effort required to replace and/or update point-of-sale devices, implementing new functionalities or workflows via point-of-sale devices can be difficult and sometimes even impossible. Accordingly, conventional systems that process card-originated payment transactions are unable to quickly adapt to accommodate emerging technologies and transaction methods.

Because conventional systems require point-of-sale devices and other infrastructure with specific hardware/software configurations, adoption of new technologies is difficult and costly for entities involved in the transaction workflow. These difficulties also create a significant barrier to entry to new entities entering the transaction process at various stages of the workflow. These limitations typically limit the amount of innovation that can occur in the payment transaction workflow, thus resulting in a very rigid process that is not well adapted to updated technologies. Accordingly, there are a number of disadvantages with conventional payment processing and transaction systems.

### SUMMARY

This disclosure describes one or more embodiments of methods, non-transitory computer readable media, and systems that solve the foregoing problems (in addition to providing other benefits) by rerouting card-originated payment transactions from a default payment card network workflow to a blockchain system for blockchain enabled transactions. Specifically, in one or more embodiments, the disclosed systems receive a payment interchange message from a payment card network associated with the default payment card network workflow indicating a card-originated payment transaction initiated at a point-of-sale device of a recipient entity. The disclosed systems then determine payment configurations for a recipient entity based on an entity identifier from the payment interchange message. Based on the payment configurations including blockchain settings enabling blockchain transactions, the disclosed systems can reroute the card-originated payment transaction by first generating digital processing instructions for adding the card-originated payment transaction to a smart contract within the blockchain system. Additionally, the disclosed systems provide the digital processing instructions to the blockchain system to add the card-originated payment transaction to the smart contract to process the transaction according to the blockchain settings. The disclosed systems thus enable processing of card-originated payment transactions via the blockchain system while leveraging existing infrastructure.

### BRIEF DESCRIPTION OF THE DRAWINGS

The detailed description refers to the drawings briefly described below.

FIG. 1 illustrates a block diagram of a system environment in which a card transaction rerouting system is implemented in accordance with one or more implementations.

FIG. 2 illustrates a diagram of a rerouting workflow for rerouting a card-originated payment transaction from a default payment card network workflow to a blockchain system in accordance with one or more implementations.

FIGS. 3A-3F illustrate sequence-flows diagrams illustrating interactions as part of the card transaction rerouting system rerouting a card-originated payment transaction between a user and an entity in accordance with one or more implementations.

FIG. 4 illustrates a diagram of the card transaction rerouting system selecting from a plurality of decentralized finance platforms in accordance with one or more implementations.

FIG. 5 illustrates a flowchart of a series of acts for rerouting a card-originated payment transaction to a blockchain system in accordance with one or more implementations.

FIG. 6 illustrates a block diagram of an exemplary computing device in accordance with one or more implementations.

### DETAILED DESCRIPTION

This disclosure describes one or more embodiments of a card transaction rerouting system that reroutes card-originated payment transactions from a default (e.g., traditional) payment card network workflow to a blockchain system. Specifically, the card transaction rerouting system communicates with a payment card network to reroute a card-originated payment transaction between a user and a recipient entity (e.g., a merchant) based on payment configurations for the entity. For instance, the card transaction rerouting system determines payment configurations in response to receiving a payment interchange message indicating that the transaction initiated at a point-of-sale device of the recipient entity. Based on determining that the payment configurations include blockchain settings enabling blockchain transactions, the card transaction rerouting system reroutes the transaction by generating digital processing instructions for adding the transaction to a smart contract of the blockchain system. The card transaction rerouting system then utilizes the smart contract to transfer cryptocurrency funds from an account of the user to a digital wallet of the recipient entity via the blockchain system according to the digital processing instructions.

As mentioned, in one or more embodiments, the card transaction rerouting system receives a payment interchange message from a payment card network. In particular, the card transaction rerouting system communicates with the payment card network in connection with processing card-originated payment transactions. In response to the payment card network receiving an indication of a card-originated payment transaction initiated at a point-of-sale device of a recipient entity using a card associated with the card transaction rerouting system, the payment card network notifies the card transaction rerouting system of the transaction. For instance, the payment card network generates the payment interchange message including an entity identifier corresponding to the recipient entity. In additional embodiments, the payment card network also receives indications of card-originated payment transactions initiated via an online purchase transaction such as via a web-based application (e.g., a browser or standalone application). In further embodiments, the payment card network receives indications of payment transactions for peer-to-business or peer-to-peer payments via mobile applications.

In one or more embodiments, the card transaction rerouting system determines payment configurations for an entity in response to receiving a payment interchange message from a payment card network. Specifically, the card transaction rerouting system obtains an entity identifier associated with a recipient entity from the payment interchange message. The card transaction rerouting system can then determine payment configurations including blockchain settings that enable blockchain transactions via the blockchain system for the recipient entity. To illustrate, the blockchain settings can also include preferences for the recipient entity such as, but not limited to, a risk level for the recipient entity, settlement preferences for settling the card-originated payment transaction, and cryptocurrency preferences.

According to one or more additional embodiments, the card transaction rerouting system reroutes a card-originated payment transaction to a blockchain system based on blockchain settings for a recipient entity. In particular, the card transaction rerouting system utilizes the blockchain settings to generate digital processing instructions for adding the card-originated payment transaction to a smart contract within the blockchain system. For instance, the card transaction rerouting system utilizes one or more layers of an application programming interface at the card transaction rerouting system to generate instructions for performing various operations associated with processing and settling the card-originated payment transaction. In some embodiments, the card transaction rerouting system also notifies the payment card network that the card transaction rerouting system is rerouting the transaction and that settlement may occur at a different time than for a default payment card network workflow involving the payment card network.

To illustrate, in one or more embodiments, the card transaction rerouting system utilizes an authorization layer to generate digital processing instructions for authorizing the card-originated payment transaction with a cryptocurrency exchange platform associated with a sender user. In one or more additional embodiments, the card transaction rerouting system utilizes a service layer to generate digital processing instructions for settling the card-originated payment transaction according to the blockchain settings. In one or more further embodiments, the card transaction rerouting system utilizes an aggregator layer to select a decentralized finance platform from a plurality of available decentralized finance platforms according to the blockchain settings.

After generating digital processing instructions utilizing one or more layers of an application programming interface, in one or more embodiments, the card transaction rerouting system provides the digital processing instructions to the blockchain system. In particular, the card transaction rerouting system provides the digital processing instructions to a smart contract of the blockchain system. The smart contract of the blockchain system then executes the provided digital processing instructions to process and settle the card-originated payment transaction via the blockchain system in accordance with the blockchain settings and payment configurations of the recipient entity.

In one or more embodiments, by rerouting a card-originated payment transaction from a default payment card network workflow via a payment card network to a blockchain system, the card transaction rerouting system provides additional yield associated with the card-originated payment transaction. Specifically, the digital processing instructions cause the smart contract to delay settlement of funds of the card-originated payment transaction from the blockchain system, which thereby determines the overall yield from the funds residing in the blockchain system. Additionally, in one or more embodiments, the digital processing instructions cause the smart contract to pull the funds after reaching one or more thresholds based on the blockchain settings and distribute the funds, with a portion of the additional yield, to the recipient entity (e.g., to a digital wallet), in addition to providing a portion of the additional yield (or funds) to the payment card network (e.g., for processing fees), the card transaction rerouting system, and/or the sender user (e.g., a funding cryptocurrency account).

The disclosed card transaction rerouting system provides a number of benefits over conventional systems. For example, the card transaction rerouting system improves the flexibility of computing devices and systems that process card-originated payment transactions. In contrast to existing systems that restrict processing card-originated payment transactions to a specific payment configuration and currency, the card transaction rerouting system processes different transaction types and additional currency types (e.g., cryptocurrencies). Specifically, the card transaction rerouting system provides customization of payment transactions by modifying settlement times, decentralized finance platforms, or other aspects of card-originated payment transactions by rerouting the transactions to a blockchain system.

Additionally, by rerouting card-originated payment transactions from default workflows to a blockchain system, the card transaction rerouting system further improves the usability and flexibility of existing payment processing rail infrastructure. In particular, while the existing systems require updating hardware and software or replacement of point-of-sale devices to adopt new technologies or processes, the card transaction rerouting system uses existing point-of-sale devices to reroute processing to a blockchain system. For example, the card transaction rerouting system leverages the existing infrastructure with a plurality of application programming interface layers to allow the transfer of cryptocurrency funds without requiring replacement or updating of point-of-sale devices at merchant/entity locations. To illustrate, the card transaction rerouting system utilizes the application programming interface to communicate with additional systems (e.g., the blockchain system) and generate digital processing instructions for execution by a smart contract of the blockchain system.

In addition to the flexibility benefits provided by the application programming interface, the card transaction rerouting system also provides additional benefits related to card-originated payment transactions. Specifically, by rerouting card-originated payment transactions from a traditional workflow to a blockchain system using existing infrastructure, the card transaction rerouting system lowers transaction costs to merchants while increasing the availability of cryptocurrency transactions to consumers and merchants. For instance, by using existing infrastructure to modify the processing of card-originated payment transactions, the card transaction rerouting system eliminates the need for merchants to upgrade or replace existing point-of-sale devices. Furthermore, the card transaction rerouting system reduces costs to merchants and increases incentives to customers to utilize card-originated payment transactions for cryptocurrency exchanges via additional yields generated via the blockchain system.

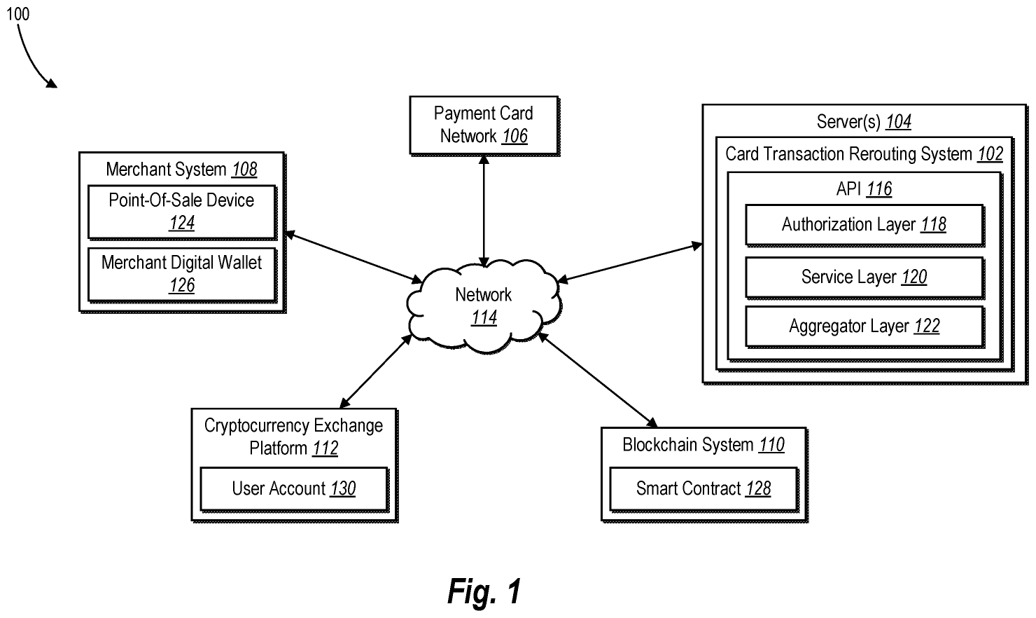

Turning now to the figures, FIG. 1 includes an embodiment of a system environment 100 in which a card transaction rerouting system 102 operates. In particular, the system environment 100 includes server(s) 104, a payment card network 106, a merchant system 108, a blockchain system 110, and a cryptocurrency exchange platform 112 in communication via a network 114. Moreover, as shown, the server(s) 104 include the card transaction rerouting system 102. Furthermore, FIG. 1 illustrates that the card transaction rerouting system 102 includes an application programming interface (“API 116”), which further includes an authorization layer 118, a service layer 120, and an aggregator layer 122. Additionally, the merchant system 108 includes a point-of-sale device 124 and a merchant digital wallet 126. Also, as illustrated, the blockchain system 110 includes a smart contract 128, and the cryptocurrency exchange platform 112 includes a user account 130.

As shown in FIG. 1, the server(s) 104 include or host the card transaction rerouting system 102. The server(s) 104 communicate with one or more other components in the system environment 100 to process card-originated payment transactions. Specifically, the card transaction rerouting system 102 communicates with the payment card network 106 to determine card-originated payment transactions for rerouting via the blockchain system 110. For example, the payment card network 106 receives an indication from the merchant system 108 of a card-originated payment transaction via the point-of-sale device 124. In some embodiments, the payment card network 106 communicates with the merchant system 108 utilizing standard payment protocols (e.g., Payment Card Industry Data Security Standard) via a payment gateway system.

As used herein, the term “card-originated payment transaction” refers to a transaction to transfer funds initiated via an issued payment card associated with a payment account of a sender. For example, a card-originated payment transaction includes a request to transfer funds in response to a credit card, debit card, or gift card swipe (or other method of payment card input) at a point-of-sale device. In various embodiments, a card-originated payment transaction includes a transaction initiated by a physical credit card or debit card associated with a payment account. In alternative embodiments, a card-originated payment transaction includes a transaction initiated by a digital credit card or debit card associated with a payment account (e.g., via a mobile device).

Additionally, as used herein, the term “payment card network” refers to an entity that facilitates transactions between merchants and card issuers by communicating with merchants for initiating card-originated payment transactions. For example, a payment card network receives a request from a point-of-sale device of an entity to initiate a card-originated payment transaction. Examples of payment card networks include VISA, DISCOVER, and MASTERCARD. In addition, payment card networks can communicate with other components of a payment network (e.g., issuers, processing systems, acquiring banks) including the card transaction rerouting system to process payment transactions.

The payment card network 106 then sends a payment interchange message to the card transaction rerouting system 102 including information about the card-originated payment transaction initiated via the point-of-sale device 124. In one or more embodiments, a “payment interchange message” refers to a message including information about a transaction according to payment protocols (e.g., an “ISO” message according to a standard for card-originated payment transactions). The payment card network 106 thus communicates with the card transaction rerouting system 102 as part of routine payment transaction communications.

As used herein, the term “point-of-sale device” refers to a hardware system for processing card-originated payment transaction at in-person locations. For instance, a point-of-sale device includes a terminal with one or more input methods for reading physical or digital payment cards. To illustrate, a point-of-sale device includes a magnetic strip reader, a chip reader, or a near-field communication sensor to determine a payment account associated with a payment card. In some embodiments, the point-of-sale device 124 is located at a merchant location associated with the merchant system 108 for customers to initiate payment transactions for goods or services.

In one or more embodiments, after receiving payment interchange messages from the payment card network 106, the card transaction rerouting system 102 reroutes card-originated payment transactions via the blockchain system 110. For example, the card transaction rerouting system 102 utilizes the API 116 (e.g., the authorization layer 118) to communicate with the cryptocurrency exchange platform 112 to authorize a card-originated payment transaction in connection with the user account 130. Furthermore, the card transaction rerouting system 102 utilizes the service layer 120 of the API 116 to generate digital processing instructions to provide to the smart contract 128 of the blockchain system 110 to process the card-originated payment transaction according to payment configurations associated with the merchant system 108. The card transaction rerouting system 102 also utilizes the aggregator layer 122 of the API 116 to select from a plurality of available decentralized finance platforms for processing the card-originated payment transaction. In alternative embodiments, the card transaction rerouting system 102 utilizes other configurations of layers in the API 116 to perform the actions (e.g., via instructions to a smart contract) than described above.

As used herein, the term “payment configurations” refer to preferences or settings for performing payment transactions associated with a particular entity. In one or more embodiments, payment configurations include settings associated with processing cryptocurrency transactions associated with a merchant. To illustrate, payment configurations can include blockchain settings that enable blockchain transactions for the merchant. Additionally, as used herein, the term “blockchain settings” refers to settings for processing blockchain transactions for an entity. Accordingly, blockchain settings include preferences such as, but not limited to, a risk level (e.g., risk tolerance) of a merchant for blockchain transactions, settlement preferences for setting a card-originated payment transaction via a blockchain system, and cryptocurrency preferences for indicating one or more types of cryptocurrencies for blockchain transactions involving the merchant.

As used herein, the term “decentralized finance platform” refers to a lending platform associated with one or more decentralized currencies. To illustrate, a decentralized finance platform includes a blockchain-based platform for cryptocurrencies that does not rely on a central financial intermediary (e.g., a brokerage). In some embodiments, a decentralized finance platform is accessible via a network connection according to a particular protocol that serves one or more open financial applications. Decentralized finance platforms include, but are not limited to, Compound, Aave, Uniswap, Curve, Yearn, or Celsius.

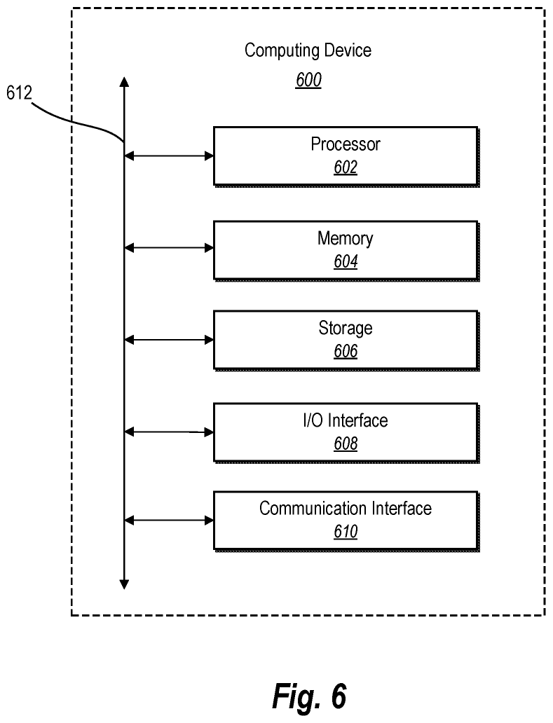

Additionally, the card transaction rerouting system 102 communicates with the blockchain system 110 to provide the digital processing instructions to the smart contract 128. As used herein, the term “blockchain system” refers to computing devices and computing systems on which a plurality of blockchain transactions are processed. Specifically, a blockchain system includes one or more digital ledgers of transactions involving one or more decentralized finance platforms for transferring decentralized currencies (e.g., cryptocurrencies). Additionally, a blockchain system includes a smart contract for processing blockchain transactions. For example, as illustrated in FIG. 1, the blockchain system 110 includes one or more computing devices (e.g., server devices), such as those described with respect to FIG. 6 below, configured to store and execute instructions from smart contracts associated with a plurality of blockchain transactions via the card transaction rerouting system 102 or other systems in communication with the blockchain system 110.

In one or more embodiments, the smart contract 128 (or computing device(s) hosting the smart contract 128) processes the card-originated payment transaction by communicating with the cryptocurrency exchange platform 112 to pull funds from the user account 130. The smart contract 128 can then deposit the funds in the blockchain system 110 for an amount of time according to the payment configurations associated with the merchant system 108. As used herein, the term “smart contract” refers to a computer program or transaction protocol that executes digital processing instructions for blockchain transactions. Accordingly, a smart contract resides on one or more computing devices that execute digital processing instructions to transfer funds between two or more accounts via a blockchain system. Additionally, a smart contract (e.g., the computing device(s) on which the smart contract resides) executes digital processing instructions to transfer funds into and out of one or more decentralized finance platforms for generating additional funds (e.g., yield) during processing and settling a blockchain transaction.

In additional embodiments, the smart contract 128 of the blockchain system 110 settles the funds, along with a determined yield amount, by pulling the funds from the blockchain system 110 and distributing the funds according to the digital processing instructions. For instance, the smart contract 128 provides the funds to the merchant digital wallet 126 of the merchant system 108. The smart contract 128 can also distribute the additional yield amount to one or more components of the system environment 100 (e.g., the merchant system 108, the card transaction rerouting system 102, the payment card network 106, and/or the cryptocurrency exchange platform 112) based on the digital processing instructions.

In one or more embodiments, the server(s) 104 include a variety of computing devices, including those described below with reference to FIG. 6. For example, the server(s) 104 includes one or more servers for storing and processing data associated with processing card-originated payment transactions. In some embodiments, the server(s) 104 also include a plurality of computing devices in communication with each other, such as in a distributed storage environment. In some embodiments, the server(s) 104 communicate with a plurality of payment card networks (including the payment card network 106) based on established relationships between the card transaction rerouting system 102 and the payment card networks. In additional embodiments, the server(s) 104 communicate with other entities or systems including financial institutions (e.g., issuing banks associated with payment cards), a plurality of different cryptocurrency exchange platforms, and/or a plurality of merchant systems based on relationships between the card transaction rerouting system 102 and the various systems.

In addition, in one or more embodiments, the merchant system 108 includes one or more computing devices such as those described below with reference to FIG. 6. For instance, the merchant system 108 includes a plurality of point-of-sale devices at one or more merchant locations. Additionally, the merchant system 108 can include one or more computing devices to store the merchant digital wallet 126 or to interact with a separate system that includes the merchant digital wallet 126. In additional embodiments, the merchant system 108 includes or communicates with one or more systems for interacting with components of the system environment 100 in connection with processing payment transactions involving decentralized currencies or centralized currencies.

Additionally, as shown in FIG. 1, the system environment 100 includes the network 114. The network 114 enables communication between components of the system environment 100. In one or more embodiments, the network 114 may include the Internet or World Wide Web. Additionally, the network 114 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the payment card network 106, the merchant system 108, the blockchain system 110, and the cryptocurrency exchange platform 112 communicate via the network using one or more communication platforms and technologies suitable for transporting data and/or communication signals, including any known communication technologies, devices, media, and protocols supportive of data communications, examples of which are described with reference to FIG. 6. Additionally, in one or more embodiments, the various components of the system environment 100 communicate using protocols for card-originated payment transactions and decentralized finance transactions.

As illustrated, in one or more embodiments, the card transaction rerouting system 102 flexibly reroutes blockchain transactions for users and recipient entities for which blockchain transactions are enabled. In particular, the card transaction rerouting system 102 processes blockchain transactions for a recipient entity by rerouting a default payment card network workflow involving the payment card network 106 to the blockchain system 110. Accordingly, the card transaction rerouting system 102 provides flexibility to processing payments between consumers and merchants by adjusting the standard processing workflow to allow the merchant system 108 to receive funds involving decentralized currencies. In additional embodiments, the card transaction rerouting system 102 provides transaction processing via the default workflow (e.g., via the payment card network 106) for entities and/or transactions for which blockchain transactions are not enabled.

Although FIG. 1 illustrates the system environment 100 including components for processing card-originated payment transactions initiated via point-of-sale devices, in one or more additional embodiments, the card transaction rerouting system 102 also flexibly reroutes blockchain transactions based on card-originated payment transactions initiated via online interfaces or mobile applications. For example, some payment cards are associated with digital versions for use in initiating payment transactions with merchants via online stores (e.g., via a web-based application or standalone application on a client device of a user) or with other users via mobile applications by way of the payment card network 106. The card transaction rerouting system 102 can receive an indication of a payment transaction initiated via an online interface or a mobile application from the payment card network 106. The card transaction rerouting system 102 can also determine that the payment transaction is a blockchain transaction based on the blockchain settings for a recipient entity.

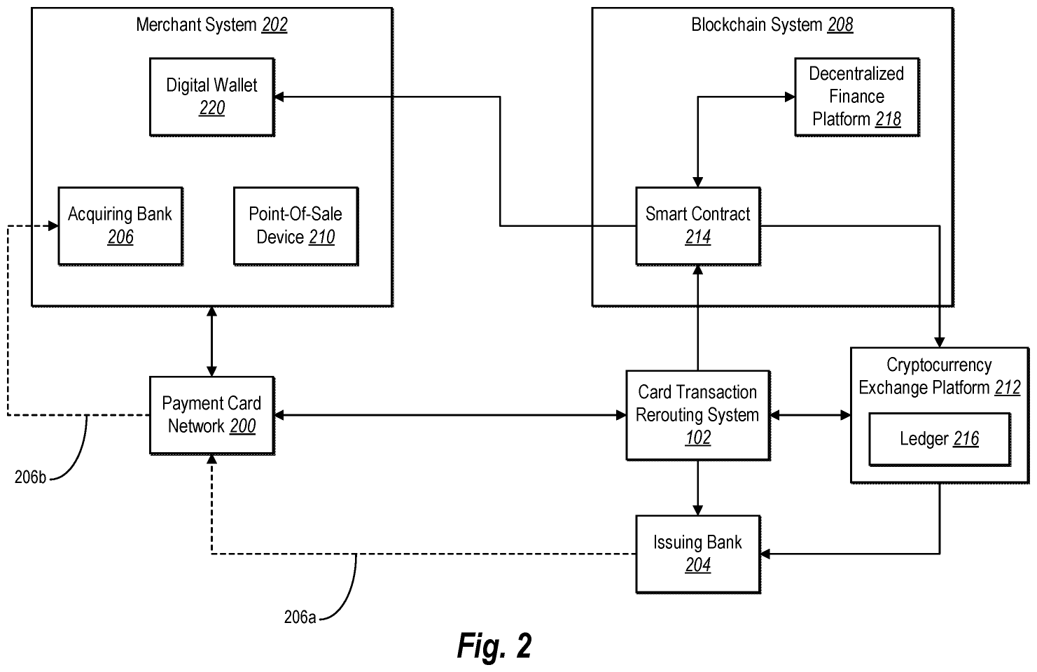

As mentioned, FIG. 2 illustrates a diagram of a rerouting workflow for rerouting a card-originated payment transaction from a default payment card network workflow to a blockchain system. Specifically, FIG. 2 illustrates that the card transaction rerouting system 102 communicates with a plurality of systems and entities to reroute card-originated payment transactions from a default/standard workflow to a blockchain. Accordingly, FIG. 2 illustrates that the card transaction rerouting system 102 determines to reroute each card-originated payment transaction according to properties of the card-originated payment transaction and capabilities of the various systems/devices involved in the transaction.

FIG. 2 illustrates a default payment card network workflow involving a payment card network 200. Specifically, in response to the payment card network 200 receiving an indication of a card-originated payment transaction from a merchant system 202, the payment card network 200 initiates the payment transaction with an issuing bank 204 associated with a payment card for the card-originated payment transaction. Specifically, the payment card network 200 can initiate a wire drawdown from a settlement account (e.g., associated with a sender user) at the issuing bank 204, as illustrated by a first dashed line 206a. The payment card network 200 can then send the settlement funds provided by the settlement account to an acquiring bank 206 associated with the merchant system 202, as illustrated by a second dashed line 206b.

As previously noted, while the default payment card network workflow provides payment transaction processing for traditional card-originated payment transactions involving centralized currencies, the default payment card network workflow is not capable of processing certain transactions. In particular, the default payment card network workflow is unable to handle non-traditional payment transactions, such as those involving decentralized currencies using the current infrastructure. Accordingly, the card transaction rerouting system 102 communicates with the payment card network 200 to reroute processing of a card-originated payment transaction involving a decentralized currency to a blockchain system 208.

In one or more embodiments, as illustrated in FIG. 2, the payment card network 200 communicates with the merchant system 202 to receive an indication of a card-originated payment transaction. For example, the merchant system 202 includes a point-of-sale device 210 to read a physical or digital payment card in connection with a purchase or other transaction by a consumer. The merchant system 202 sends a payment message to the payment card network 200 including information about the card-originated payment transaction.

After the payment card network 200 receives the payment message including information for a payment transaction, as illustrated in FIG. 2, the payment card network 200 sends a payment interchange message to the card transaction rerouting system 102. In one or more embodiments, the payment interchange message includes the information for the payment transaction received in the payment message. Furthermore, the payment card network 200 can include information about the merchant system 202 (e.g., by including a merchant identifier).

In response to receiving the payment interchange message from the payment card network 200, the card transaction rerouting system 102 determines whether to reroute the card-originated payment transaction via the blockchain system 208. For example, the card transaction rerouting system 102 determines payment configurations for the merchant system 202 based on the information in the payment interchange message (e.g., based on the merchant identifier). In particular, the card transaction rerouting system 102 determines whether the payment configurations include blockchain settings that enable blockchain transactions for the merchant system 202. Additionally, the card transaction rerouting system 102 can determine payment configurations for processing the payment such as, but not limited to, settlement preferences, currency preferences, risk preferences, or routing preferences.

In one or more embodiments, after determining to reroute a card-originated payment transaction to the blockchain system 208, the card transaction rerouting system 102 notifies the payment card network 200 of the rerouted transaction. Specifically, the card transaction rerouting system 102 notifies the payment card network 200 that settlement of the card-originated payment transaction will occur differently than for a standard card-originated payment transaction processed via the default payment card network workflow. Additionally, in some embodiments, the card transaction rerouting system 102 notifies the payment card network 200 of an estimated time frame for settling the card-originated payment transaction according to the payment configurations.

Furthermore, as illustrated in FIG. 2, the card transaction rerouting system 102 communicates with a cryptocurrency exchange platform 212 associated with a sender account for the card-originated payment transaction. In one or more embodiments, the card-originated payment transaction includes information to transfer funds from a cryptocurrency account of a sender user to the merchant system 202. Accordingly, the card transaction rerouting system 102 communicates with the cryptocurrency exchange platform 212 to authorize the card-originated payment transaction based on the sender user's cryptocurrency account.

In one or more embodiments, the card transaction rerouting system 102 provides a Just-In-Time (“JIT”) funding message to the cryptocurrency exchange platform 212 to fund and authorize the card-originated payment transaction in real-time. In some embodiments, the cryptocurrency exchange platform 212 communicates with the issuing bank 204 to obtain program reserve funding (e.g., via clearing house or wire transfer) to fund the transaction. In alternative embodiments, the card transaction rerouting system 102 provides the JIT funding message directly to a customer if the customer manages the balance of the cryptocurrency account.

Based on the cryptocurrency exchange platform 212 approving the card-originated payment transaction, the card transaction rerouting system 102 generates digital processing instructions for the card-originated payment transaction. According to one or more embodiments, the card transaction rerouting system 102 generates digital processing instructions based on the payment configurations and blockchain settings. More specifically, the card transaction rerouting system 102 generates the digital processing instructions to include in a smart contract 214 at the blockchain system 208. In one or more embodiments, the card transaction rerouting system 102 generates the smart contract 214 for including in the blockchain system 208.

In one or more embodiments, card transaction rerouting system 102 provides the digital processing instructions to the blockchain system 208 for inclusion in the smart contract 214. The blockchain system 208 then executes the digital processing instructions in the smart contract 214 to process the card-originated payment transaction according to the payment configurations. For instance, the smart contract 214 communicates with the cryptocurrency exchange platform 212 to fund the card-originated payment transaction from the sender user's account. In response, the cryptocurrency exchange platform 212 can then update the ledger 216 based on the payment amount.

Furthermore, the smart contract 214 transfers the funds obtained from the sender user's account to a decentralized finance platform 218 in the blockchain system 208. In particular, the smart contract 214 transfers the funds to the decentralized finance platform 218 to gain a yield based on the payment configurations. For example, the digital processing instructions include instructions to transfer the funds to a specific decentralized finance platform. In various embodiments, the smart contract 214 maintains the funds with the decentralized finance platform 218 for a specific amount of time (e.g., a certain number of days) and/or based on another threshold (e.g., a certain yield percentage).

Once the threshold(s) are met, the smart contract 214 executes digital processing instructions to pull the funds from the decentralized finance platform 218 including any additional yield earned from the funds being deposited with the decentralized finance platform 218. In one or more embodiments, for example, the smart contract 214 executes digital processing instructions to transfer the funds to a digital wallet 220 of the merchant system 202. In one or more embodiments, the digital wallet 220 stores the funds in the cryptocurrency transferred from the blockchain system 208 for the merchant system 202. Accordingly, the card transaction rerouting system 102 facilitates the transfer of cryptocurrency funds for a card-originated payment transaction via the blockchain system 208.

In one or more embodiments, the card transaction rerouting system 102 also distributes the yield obtained from depositing the funds with the decentralized finance platform 218 to one or more entities based on the payment configurations. For example, the card transaction rerouting system 102 distributes at least a portion of the yield to the digital wallet 220 (e.g., via digital processing instructions provided to the smart contract 214). In additional examples, the card transaction rerouting system 102 also provides a portion of the yield to the sender user's account with the cryptocurrency exchange platform 212. In some embodiments, the card transaction rerouting system 102 also provides a portion of the yield to payment card network 200 for transaction fees. Furthermore, in some embodiments, the card transaction rerouting system 102 keeps a portion of the yield.

Although FIG. 2 illustrates that the card transaction rerouting system 102 settles a card-originated payment transaction via the blockchain system 208 by directly transferring funds from the blockchain system 208 to the digital wallet 220 of the merchant system 202, in other embodiments, the card transaction rerouting system 102 settles funds via another route. For example, in some embodiments, the card transaction rerouting system 102 settles the card-originated payment transaction by communicating with the payment card network 200 to transfer the funds to the merchant system 202 via the payment card network 200. To illustrate, the smart contract 214 may correspond to the payment card network 200 such that during settlement, the card transaction rerouting system 102 causes the funds to transfer from the decentralized finance platform 218 to a settlement account of the payment card network 200. The payment card network 200 can then proceed to settle the funds for the transaction. Furthermore, in embodiments in which the card transaction rerouting system 102 determines that blockchain transactions are not enabled for a given card-originated payment transaction or merchant system, the card transaction rerouting system 102 can communicate with the issuing bank 204 to transfer the funds utilizing the default payment card network workflow.

In additional embodiments, the card transaction rerouting system 102 settles a transaction in different currencies. For example, in some implementations, the card transaction rerouting system 102 settles with the merchant system 202 to deposit the transferred funds in a centralized currency (e.g., dollars), while the transaction funded using a cryptocurrency. Additionally, the card transaction rerouting system 102 can also settle a portion of funds in a first currency and another portion of the funds (e.g., the yield) in a second currency depending on the preferences of the recipient entity and/or the entity receiving the yield (e.g., the payment card network 200, the card transaction rerouting system 102, the sender user, or the issuing bank 204).

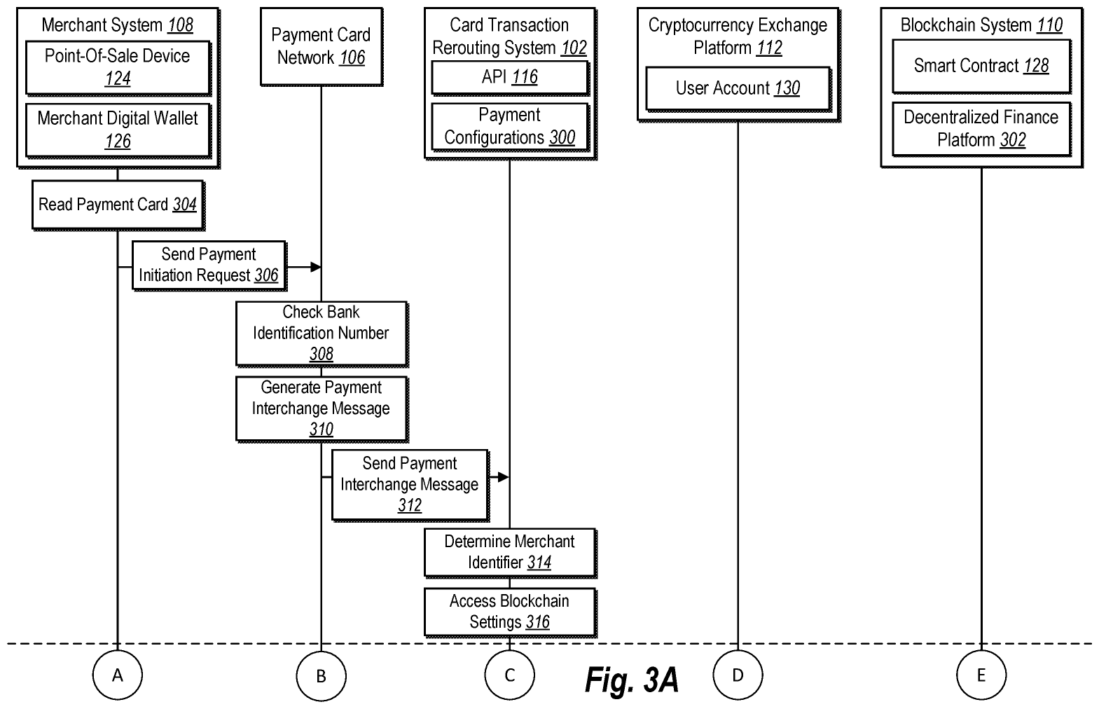

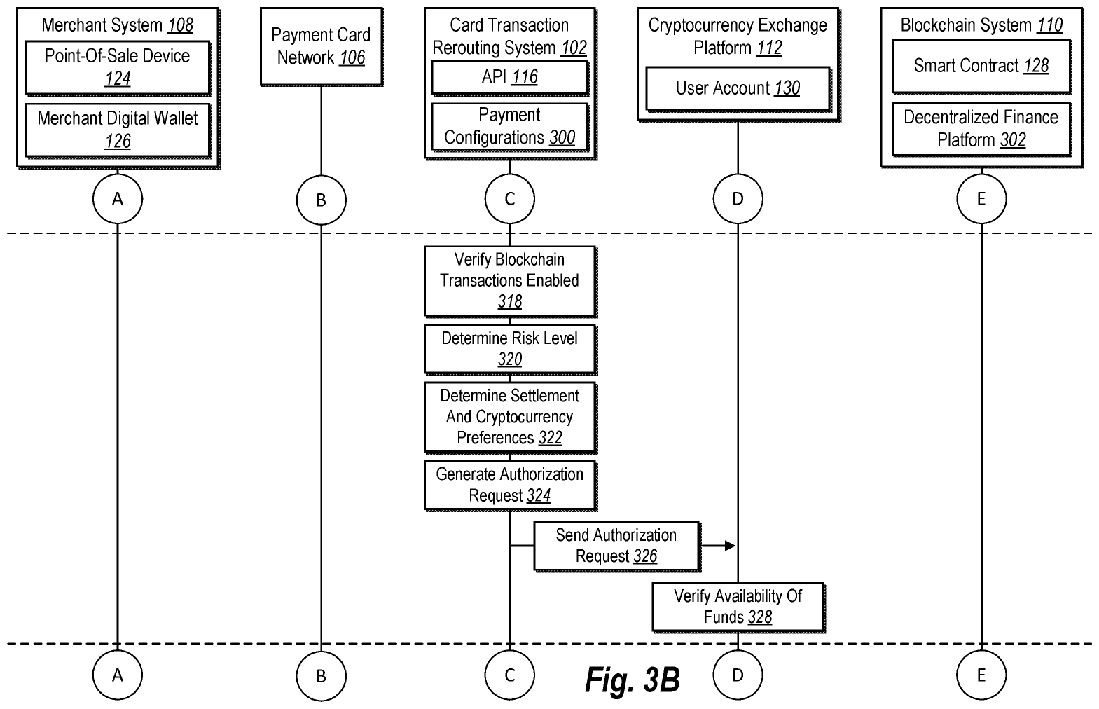

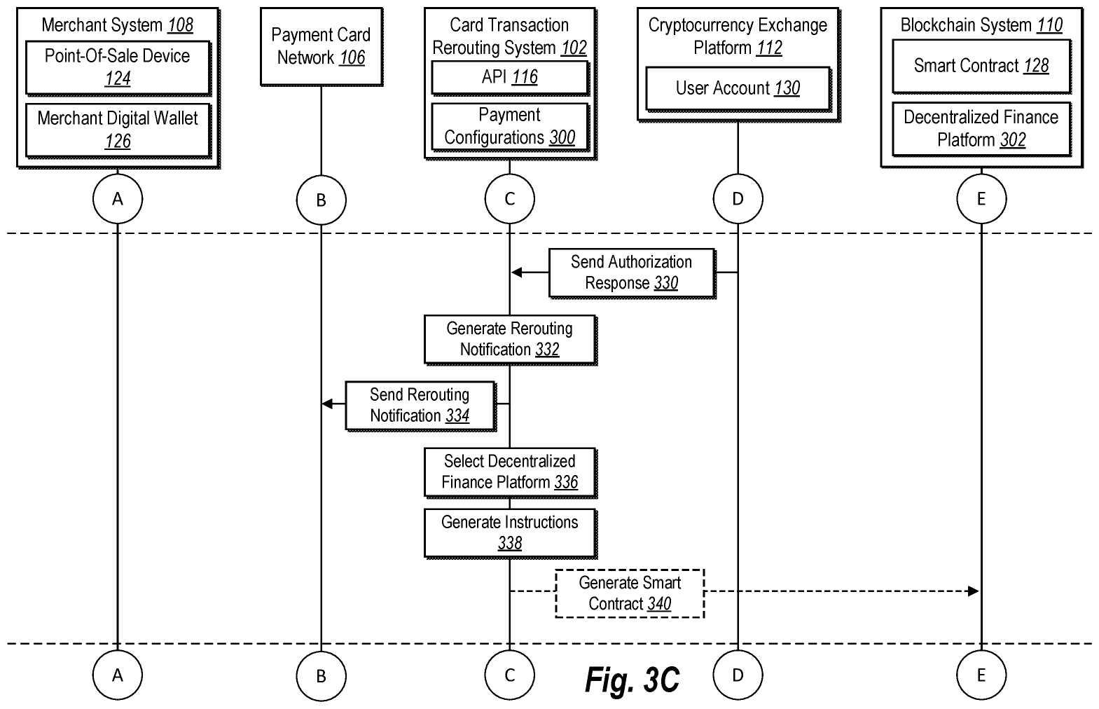

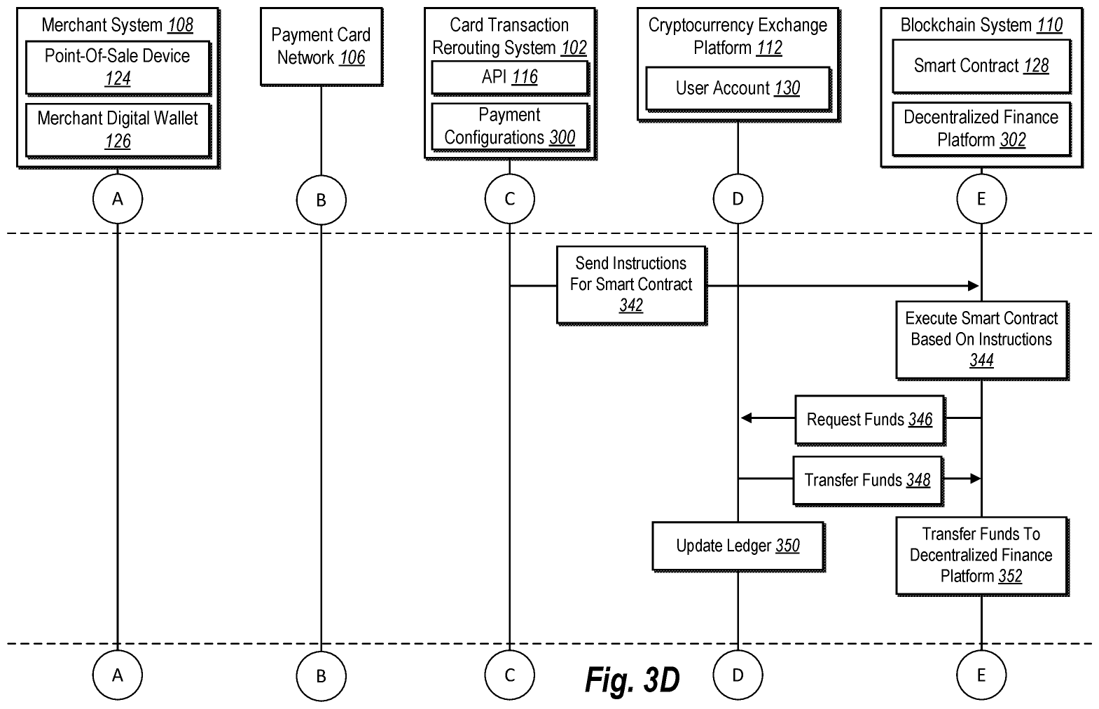

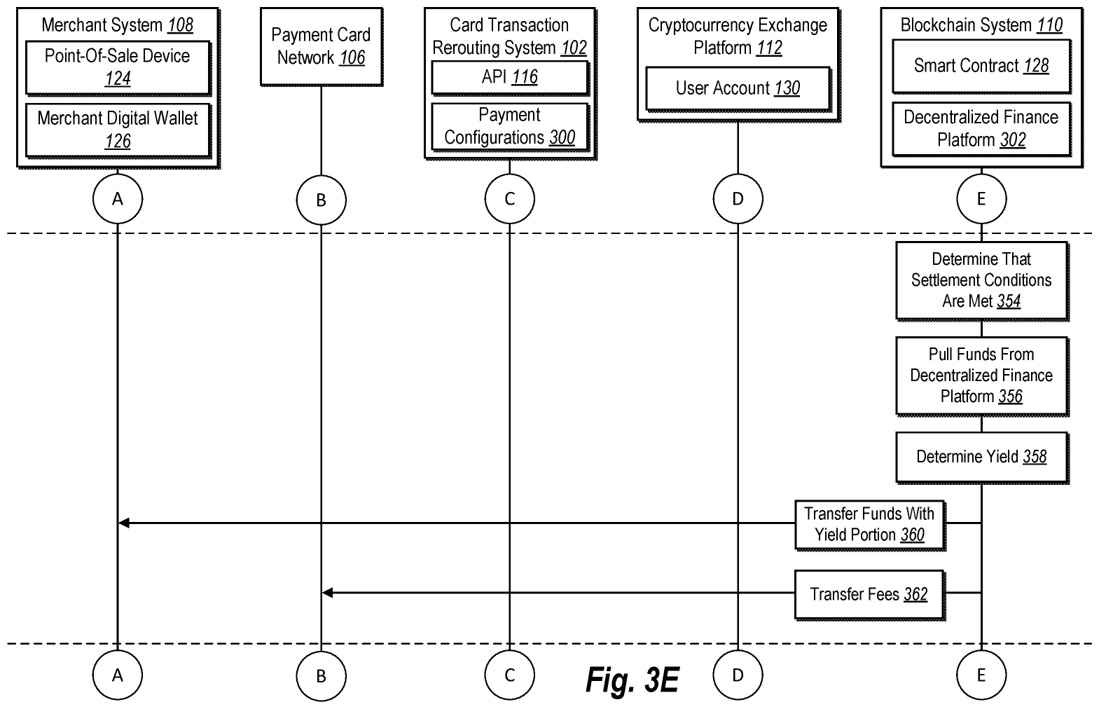

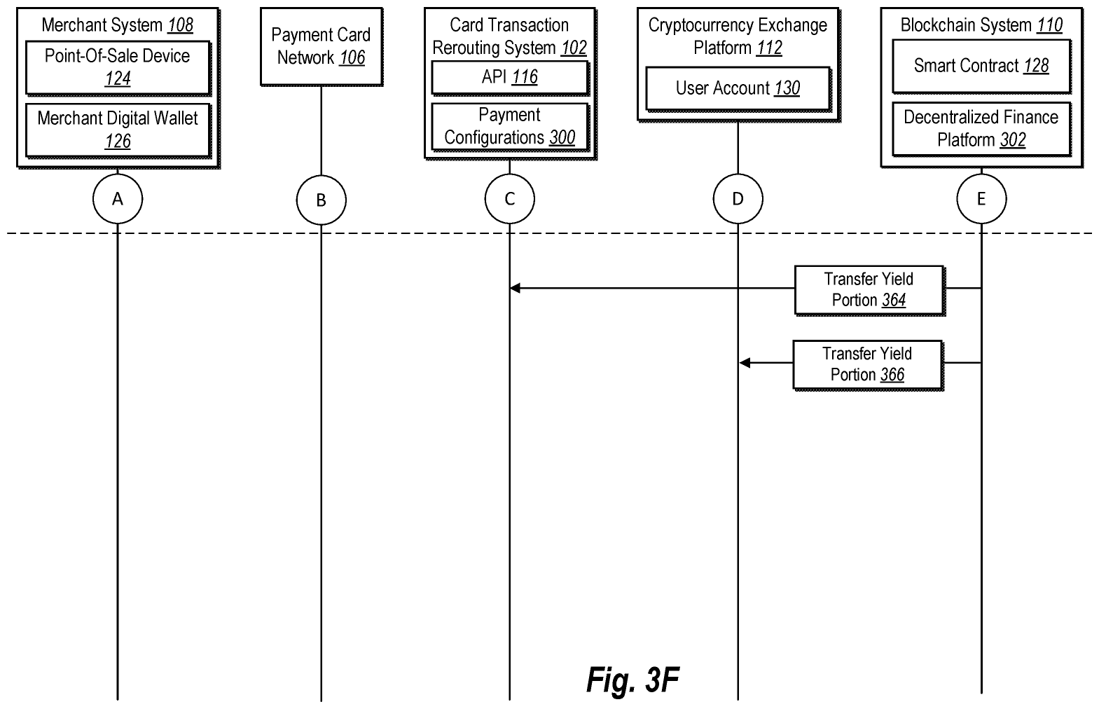

FIGS. 3A-3F illustrate example process diagrams associated with rerouting a card-originated payment transaction from a default workflow to a blockchain workflow. Specifically, consistent with the system environment of FIG. 1, FIGS. 3A-3F illustrate the card transaction rerouting system 102, the merchant system 108, the payment card network 106, the cryptocurrency exchange platform 112, and the blockchain system 110. Furthermore, as illustrated, the merchant system 108 includes the point-of-sale device 124 and the merchant digital wallet 126. Additionally, the card transaction rerouting system 102 includes the API 116 and further includes payment configurations 300. The cryptocurrency exchange platform 112 includes the user account 130. As illustrated, the blockchain system 110 includes the smart contract 128 and a decentralized finance platform 302.

In one or more embodiments, FIG. 3A illustrates that a process for a sender user to engage in a blockchain transaction with a recipient entity (e.g., the merchant system 108) begins with the merchant system 108 performing an act 304 of reading a payment card. In particular, the merchant system 108 utilizes the point-of-sale device 124 to read the payment card of the sender user at an in-person location such as a merchant location (e.g., an in-store location). For example, the point-of-sale device 124 includes a magnetic card reader or a chip reader to read a physical credit card or debit card and determine a payment account for performing the blockchain transaction. In alternative embodiments, the point-of-sale device 124 includes a near-field communication sensor to read a digital payment card, such as a digital payment card stored on a mobile device (e.g., a smartphone).

In one or more additional embodiments, the merchant system 108 provides an online interface for processing payment transactions. For instance, the merchant system 108 can provide a web-based application (e.g., a browser) or a standalone application (e.g., a mobile application associated with the merchant system 108) for purchasing goods or services with digital versions of payment cards. The merchant system 108 can integrate an online payment mechanism within the web-based application or mobile application for users to engage in card-originated payment transactions using payment cards associated with the payment card network 106. The merchant system 108 can thus identify card-originated payment transactions initiated via the point-of-sale device 124 and/or via one or more online interfaces by reading payment card data according to various physical or digital card-reading mechanisms.

In one or more alternative embodiments, another system (e.g., a peer-to-peer transaction system) identifies a peer-to-peer payment transaction initiated via a payment application (e.g., a mobile payment application). The system can determine that the peer-to-peer payment transaction is associated with a particular payment card based on application settings or user profile information associated with the payment application. Additionally, the system can determine that the payment transaction corresponds to the payment card network 106 based on information associated with the payment card (e.g., based on a bank identification number). The system can thus process the payment transaction initiated in the payment application with the payment card network 106.

After reading the payment card associated with initiating a transaction, FIG. 3A illustrates that the merchant system 108 performs an act 306 of sending a payment initiation request to a payment card network 106. For example, the merchant system 108 generates (e.g., via the point-of-sale device 124) the payment initiation request including information about the transaction. To illustrate, the payment initiation request includes a payment amount of the transaction, a payment account of the sender or a token representing the payment account of the sender, and a merchant identifier associated with the merchant system 108.

FIG. 3A illustrates that the payment card network 106 then performs an act 308 of checking a bank identification number associated with the payment card. Specifically, the payment card network 106 can use the bank identification number to determine which entity to contact for processing the transaction. For instance, in response to determining that the bank identification number corresponds to the card transaction rerouting system 102, the payment card network 106 determines to process the transaction by communicating with the card transaction rerouting system 102.

To communicate with the card transaction rerouting system 102 for processing the transaction, the payment card network 106 performs an act 310 of generating a payment interchange message. In particular, the payment card network 106 generates the payment interchange message according to established protocols for processing card-originated payment transactions. To illustrate, the payment card network 106 generates an International Organization for Standardization (“ISO”) message according to an established standard for systems exchanging electronic transactions initiated by payment cards. The payment interchange message can include the information about the transaction received from the merchant system 108. The payment card network 106 can then perform an act 312 of sending the payment initiation request to the card transaction rerouting system 102 to process the transaction.

As illustrated in FIG. 3A, after the card transaction rerouting system 102 receives the payment interchange message from the payment card network 106, the card transaction rerouting system 102 performs an act 314 of determining a merchant identifier associated with the merchant system 108 for the transaction. For instance, in one or more embodiments, the card transaction rerouting system 102 extracts the merchant identifier from the payment interchange message received from the payment card network 106. The card transaction rerouting system 102 can utilize the merchant identifier to identify the merchant system 108. In some instances, the merchant system 108 establishes a relationship with the card transaction rerouting system 102 to create a merchant account with the card transaction rerouting system 102 for processing blockchain transactions. Accordingly, the card transaction rerouting system 102 can store the merchant identifier for the merchant system 108 for determining the identity of the merchant system 108 during blockchain transactions (e.g., for the transaction illustrated in FIGS. 3A-3F).

According to one or more embodiments, after determining the identity of the merchant system 108 using the merchant identifier, the card transaction rerouting system 102 performs an act 316 of accessing blockchain settings associated with the merchant system 108 to determine the payment configurations 300. For instance, when establishing a merchant account with the card transaction rerouting system 102, the merchant system 108 can provide preferences or settings for processing transactions involving the merchant system 108. To illustrate, the card transaction rerouting system 102 can access a merchant profile to determine whether the merchant system 108 prefers to enable blockchain transactions for the merchant system 108. Additionally, the merchant system 108 can provide additional information for storing with the blockchain settings that the card transaction rerouting system 102 can use for determining how to settle blockchain transactions involving the merchant system 108.

In one or more embodiments, the card transaction rerouting system 102 determines the payment configurations 300 for the merchant system 108 based on the information previously provided by the merchant system 108. Specifically, as illustrated in FIG. 3B, the card transaction rerouting system 102 performs an act 318 of verifying the blockchain transactions are enabled for the merchant system 108. For example, the merchant system 108 can indicate to the card transaction rerouting system 102 that the merchant system 108 is available for blockchain transactions involving transfers of one or more types of cryptocurrencies between the users and the merchant system 108.

As mentioned, the card transaction rerouting system 102 can determine additional settings or preferences for processing card-originated payment transactions via the blockchain system 110. To illustrate, the card transaction rerouting system 102 can perform an act 320 of determining a risk level associated with the merchant system 108 based on the blockchain settings. More specifically, the card transaction rerouting system 102 can determine a risk tolerance of the merchant system 108 for funds deposited with the blockchain system 110. For instance, a higher risk level or risk tolerance can provide improved yield for blockchain transactions by using higher risk decentralized finance platforms, while a lower risk level or risk tolerance can provide lower yields by using lower risk decentralized finance platforms.

FIG. 3B further illustrates that the card transaction rerouting system 102 also performs an act 322 of determining settlement and cryptocurrency preferences. In particular, the card transaction rerouting system 102 determines preferences for settling blockchain transactions involving the merchant system 108. To illustrate, the card transaction rerouting system 102 can determine one or more thresholds for determining when to settle blockchain transactions. In some embodiments, the thresholds include time thresholds (e.g., a number of days) and/or a yield threshold (e.g., a percentage value or a minimum yield value).

In one or more embodiments, the cryptocurrency preferences include preferences for specific cryptocurrencies or decentralized finance platforms. For instance, the card transaction rerouting system 102 can determine that the merchant system 108 prefers, or enables blockchain transactions for, one or more cryptocurrencies. In some embodiments, the card transaction rerouting system 102 also determines that if the cryptocurrency preferences for the merchant system 108 do not include on or more cryptocurrencies, blockchain transactions for those cryptocurrencies are not enabled. Thus, the merchant system 108 can engage in blockchain transactions for certain cryptocurrencies explicitly indicated in the blockchain settings.

After determining the blockchain settings for processing blockchain transactions, the card transaction rerouting system 102 performs an act 324 of generating an authorization request for authorizing a blockchain transaction. Specifically, the card transaction rerouting system 102 utilizes the API 116 (e.g., via the authorization layer 118 as illustrated in FIG. 1) to generate the authorization request. For example, the card transaction rerouting system 102 can generate the authorization request to include a request to authorize transfer of funds from a user account associated with the sender user (e.g., associated with the payment card) to an account associated with the merchant system 108.

FIG. 3B then illustrates that the card transaction rerouting system 102 performs an act 326 of sending the authorization request to the cryptocurrency exchange platform 112. In response to receiving the authorization request, the cryptocurrency exchange platform 112 performs an act 328 of verifying availability of funds in the user account 130 associated with the payment card that initiated the card-originated payment transaction. In particular, the cryptocurrency exchange platform 112 verifies that the user account 130 includes sufficient funds to complete the transaction.

After checking the user account 130 to check availability of funds, the cryptocurrency exchange platform 112 can perform an act 330 of sending an authorization response to the card transaction rerouting system 102. Specifically, in response to determining that the user account 130 has sufficient funds, the cryptocurrency exchange platform 112 can generate the authorization response to indicate approval of the transaction. The card transaction rerouting system 102 can then proceed with rerouting the transaction to the blockchain system 110 Alternatively, if the cryptocurrency exchange platform 112 determines that the user account 130 does not have sufficient funds, the cryptocurrency exchange platform 112 generate the authorization response to reject the transaction. The card transaction rerouting system 102 then notifies the payment card network 106 of the rejected transaction for notifying the merchant system 108.

In response to an approved authorization of the transaction from the cryptocurrency exchange platform 112, in one or more embodiments, the card transaction rerouting system 102 performs an act 332 of generating a rerouting notification. In particular, the card transaction rerouting system 102 generates a notification that includes an indication that the card transaction rerouting system 102 is rerouting the transaction from the default payment card network workflow to the blockchain system 110. In one or more embodiments, the card transaction rerouting system 102 also generates the rerouting notification to include an indication that settlement of the funds will be delayed (e.g., beyond the standard 2-3 days for funds to clear via the default workflow). In some embodiments, the card transaction rerouting system 102 generates the rerouting notification to notify the payment card network 106 of an estimated time to settle the transaction. Additionally, as illustrated in FIG. 3C, the card transaction rerouting system 102 performs an act 334 of sending the rerouting notification to the payment card network 106.

In one or more embodiments, the card transaction rerouting system 102 also performs an act 336 of selecting a decentralized finance platform. Specifically, the card transaction rerouting system 102 selects the decentralized finance platform from a plurality of available decentralized finance platforms. According to one or more embodiments, the card transaction rerouting system 102 utilizes the API 116 (e.g., via the aggregator layer 122 illustrated in FIG. 1) to select the decentralized finance platform according to the payment configurations 300 and/or based on the merchant system 108 being integrated with the decentralized finance platform. For example, some decentralized finance platforms may be higher risk or lower risk than other decentralized platforms. Accordingly, the card transaction rerouting system 102 selects a particular decentralized finance platform according to the risk level and/or one or more thresholds based on the payment configurations 300.

Furthermore, as illustrated in FIG. 3C, the card transaction rerouting system 102 performs an act 338 of generating instructions for rerouting the transaction to the blockchain system 110. For instance, the card transaction rerouting system 102 generates digital processing instructions to perform a plurality of operations at the blockchain system 110 for processing the card-originated payment transaction. Additionally, the card transaction rerouting system 102 generates the digital processing instructions utilizing the API 116 (e.g., via the service layer 120 illustrated in FIG. 1). According to one or more embodiments, the card transaction rerouting system 102 thus generates digital processing instructions utilizing the API 116 to perform actions to transfer funds, deposit funds with a selected decentralized finance platform, and settle the transaction according to the payment configurations 300. More specifically, the card transaction rerouting system 102 generates the digital processing instructions to cause the blockchain system 110 to perform a plurality of operations for settling the transaction.

In one or more embodiments, as illustrated in FIG. 3C, the card transaction rerouting system 102 optionally performs an act 340 to generate a smart contract. In particular, the card transaction rerouting system 102 generates the smart contract to insert into the blockchain system 110. Additionally, as illustrated in FIG. 3D, the card transaction rerouting system 102 performs an act 342 to send instructions for the smart contract to the blockchain system 110. In some embodiments, the card transaction rerouting system 102 includes the instructions in the smart contract when the card transaction rerouting system 102 generates the smart contract. In alternative embodiments, the card transaction rerouting system 102 sends the instructions to the blockchain system 110 for a smart contract generated or provided to the blockchain system 110 by another system or entity (e.g., by the payment card network 106). In various embodiments, generating the smart contract via the card transaction rerouting system 102 or via another entity determines how to settle the transaction.

After the card transaction rerouting system 102 provides the instructions for processing the card-originated payment transaction to the blockchain system 110, the blockchain system 110 performs an act 344 of executing the smart contract based on the provided instructions. Specifically, the blockchain system 110 executes the digital processing instructions in the smart contract to initiate the payment transaction and begin transferring and settling funds according to the payment configurations. Because the card transaction rerouting system 102 generates digital processing instructions for each transaction, the blockchain system 110 executes the instructions to transfer and settle funds in a series of steps customized to the particular transaction and merchant system (e.g., according to separate smart contracts).

In one or more embodiments, the blockchain system 110 executes the smart contract 128 to perform an act 346 of requesting funds from the cryptocurrency exchange platform 112. To illustrate, the blockchain system 110 requests that the cryptocurrency exchange platform 112 requests funds from the user account 130 (e.g., from a “reserve” wallet) according to a payment amount of the transaction. Because the cryptocurrency exchange platform 112 previously authorized the transaction for the payment amount, the cryptocurrency exchange platform 112 performs an act 348 of transferring funds from the user account 130 to the blockchain system 110 in response to the request. Additionally, as illustrated in FIG. 3D, the cryptocurrency exchange platform 112 performs an act 350 of updating a ledger based on the transferred amount. In one or more embodiments, the cryptocurrency exchange platform 112 deducts the transferred amount from the user account 130 in the ledger.

According to one or more embodiments, after the blockchain system 110 executes the digital processing instructions of the smart contract 128 to perform an act 352 of transferring the funds to a decentralized finance platform. For instance, the blockchain system 110 determines the decentralized finance platform from a plurality of decentralized finance platforms based on the provided instructions in the smart contract 128. The blockchain system 110 then executes the smart contract 128 to transfer the funds to the selected decentralized finance platform.

In one or more embodiments, the blockchain system 110 executes the digital processing instructions of the smart contract 128 to perform an act 354 of determining that settlement conditions are met. In particular, as previously mentioned, the card transaction rerouting system 102 can establish one or more thresholds associated with processing blockchain transactions. Accordingly, the blockchain system 110 can determine whether one or more of those thresholds have been met after the blockchain system 110 transfers the funds to the decentralized finance platform 302.

To illustrate, the blockchain system 110 can determine that the funds have been deposited in the decentralized finance platform 302 for a threshold amount of time (e.g., based on a settlement delay time). Alternatively, the blockchain system 110 can determine that the funds have resulted in a threshold yield amount (or interest rate) or drops below the threshold yield amount. Additionally, in one or more embodiments, the blockchain system 110 can determine that a combination of thresholds are met (e.g., both the time threshold and the yield threshold). In additional embodiments, the blockchain system 110 distributes the funds in response to an indication that the merchant system 108 delivered goods corresponding the transaction.

In response to determining that the settlement conditions are met, the blockchain system 110 executes the digital processing instructions of the smart contract 128 to perform an act 356 of pulling funds from the decentralized finance platform 302. For example, after the blockchain system determines (via the smart contract 128) that the threshold conditions are met, the blockchain system 110 withdraws the funds from the decentralized finance platform 302. Additionally, the blockchain system 110 executes the digital processing instructions via the smart contract 128 to perform an act 358 of determining a yield that accrued during the transaction. More specifically, the yield is based on the risk level of the decentralized finance platform 302 and the performance of the corresponding cryptocurrency at the decentralized finance platform 302. In some embodiments, the card transaction rerouting system 102 causes the smart contract 128 to update the funds associated with the transaction based on the yield.

For example, in one or more embodiments, the blockchain system 110 determines that the decentralized finance platform 302 generates 1-1.5% yield per day. Alternatively, the blockchain system 110 determines that the decentralized finance platform 302 generates 4.5% yield per day. In various embodiments, the transaction produces different yield amounts per day based on the risk of the decentralized finance platform 302, the total time spent in the decentralized finance platform 302, or other characteristics based on the preferences of the merchant system 108.

After determining the yield, the blockchain system 110 distributes the yield according to the merchant settings, transaction characteristics, and/or other criteria associated with the transaction, payment card network 106, or card transaction rerouting system 102. For example, in one or more embodiments, as FIG. 3E illustrates, the blockchain system 110 executes the digital processing instructions of the smart contract 128 to perform an act 360 of transferring the funds with a yield portion to the merchant system 108. To illustrate, the blockchain system 110 sends the funds and the yield portion to the merchant digital wallet 126. Thus, the blockchain system 110 transfers the funds from the decentralized finance platform 302 to the merchant digital wallet 126 with at least a portion of the yield (e.g., 1% of a 4.5% total yield).

In addition to providing the funds to the merchant system 108, the blockchain system 110 can distribution one or more additional portions of the yield (or funds) to additional entities. For example, as illustrated in FIG. 3E, the blockchain system 110 executes the digital processing instructions of the smart contract 128 to perform an act 362 of transferring fees to the payment card network 106 and/or an issuing bank. In one or more embodiments, the blockchain system 110 obtains the fees for the payment card network 106 directly from the funds. In alternative embodiments, the blockchain system 110 obtains the fees from the yield. Before, or in connection with, providing the fees to the payment card network 106, in one or more embodiments, the card transaction rerouting system 102 also provides a notification to the payment card network 106 of the settlement of the blockchain transaction.

FIG. 3F further illustrates that the blockchain system 110 executes the digital processing instructions of the smart contract 128 to distribute one or more yield portions to the sender user and the card transaction rerouting system 102. For instance, the blockchain system 110 performs an act 364 to transfer a yield portion (e.g., 1%) to the card transaction rerouting system 102. In another example, the blockchain system 110 performs an act 366 to transfer a yield portion (e.g., 2.5%) to the cryptocurrency exchange platform 112 for depositing to the user account 130. In different embodiments, the blockchain system 110 distributes the yields in different amounts to different entities.

In some embodiments, the decentralized finance platform 302 generates the yield in a different form of currency than the funds deposited in the decentralized finance platform 302. For example, the decentralized finance platform 302 generates tokens based on the funds deposited with the decentralized finance platform 302. The blockchain system 110 can then provide the tokens to the card transaction rerouting system 102 as the yield portion for the card transaction rerouting system 102.

Although FIGS. 3A-3F illustrate that the card transaction rerouting system 102 generates and sends instructions to the smart contract 128 of the blockchain system 110 a single time, in other embodiments, the card transaction rerouting system 102 can communicate with the blockchain system 110 a number of times to update the smart contract 128. For example, in some embodiments, the smart contract 128 provides information to the card transaction rerouting system 102 (e.g., confirmation notifications, yield notifications). The card transaction rerouting system 102 can then utilize the information to generate updated or additional digital processing instructions and then provide the updated/additional instructions to the smart contract 128. The smart contract 128 can then execute the updated/additional instructions to continue processing the transaction.

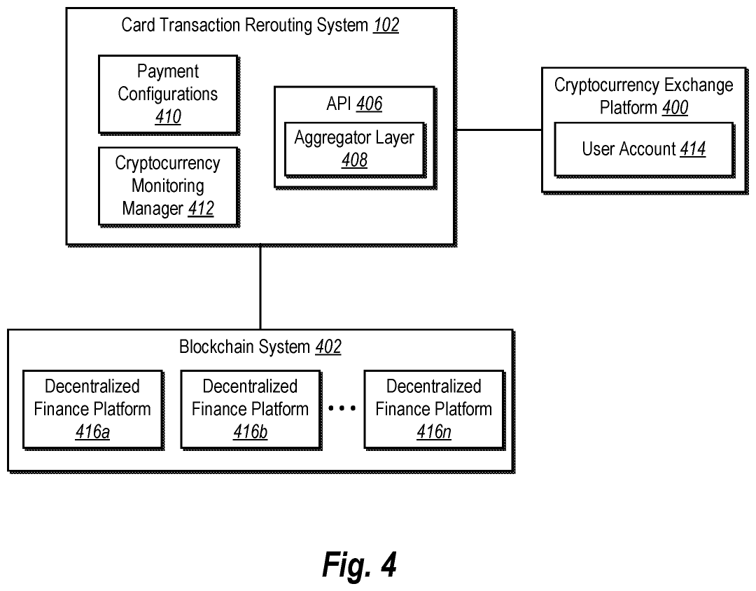

In one or more embodiments, as mentioned, the card transaction rerouting system 102 selects a decentralized finance platform from a plurality of decentralized finance platforms. For example, FIG. 4 illustrates a diagram of the card transaction rerouting system 102 selecting a decentralized finance platform for a blockchain transaction. Specifically, FIG. 4 illustrates that the card transaction rerouting system 102 selects a decentralized finance platform for transforming funds from a cryptocurrency exchange platform 400 to a blockchain system 402 based on a variety of criteria.

For example, FIG. 4 illustrates that the card transaction rerouting system 102 includes an application programming interface (“API 406”) to interface with the cryptocurrency exchange platform 400 and the blockchain system 402. In one or more embodiments, the card transaction rerouting system 102 utilizes an aggregator layer 408 of the API 406 to determine how to deposit the funds in the blockchain system 402 based on payment configurations 410 for a merchant system and a cryptocurrency monitoring manager 412. The card transaction rerouting system 102 then utilizes the aggregator layer 408 to pull funds from a user account 414 of the cryptocurrency exchange platform 400 and deposit the funds into a decentralized finance platform of a plurality of decentralized finance platforms 416a-416n.

To illustrate, the card transaction rerouting system 102 utilizes the aggregator layer 408 to integrate with one or more of the decentralized finance platforms 416a-416n. The aggregator layer 408 includes logic to determine which decentralized finance platform to use based on the payment configurations 410 (e.g., risk level, time threshold, yield threshold). Thus, the aggregator layer 408 can select a first decentralized finance platform 416a in response to determining that the payment configurations 410 include an indication that a merchant system prefers low risk transactions. Alternatively, the aggregator layer 408 can select a second decentralized finance platform 416b in response to determining that the payment configurations 410 include an indication that the merchant system prefers high risk transactions.

In addition to utilizing the payment configurations 410 to select from the decentralized finance platforms 416a-416n, in one or more embodiments, the aggregator layer 408 also communicates with the cryptocurrency monitoring manager 412 to select from the decentralized finance platforms 416a-416n. Specifically, the cryptocurrency monitoring manager 412 monitors a market volatility of specific cryptocurrencies. The aggregator layer 408 can obtain volatility measures from the cryptocurrency monitoring manager 412 and determine a risk profile of cryptocurrencies or decentralized finance platforms based on the volatility measures including, but not limited to, whether a given platform is public, how long the platform has been deployed, a liquidity pool size of each platform, and whether the platform is a yield farming protocol. Thus, the risk profiles of each decentralized finance platform can change over time based on the performance of the cryptocurrencies in the market. The aggregator layer 408 can also determine whether each protocol has a wait time to withdraw funds out of each decentralized finance platform, and the interest/yield earned each day.

The card transaction rerouting system 102 can thus select (utilizing the aggregator layer 408) a decentralized finance platform (e.g., the first decentralized finance platform 416a) for a particular payment transaction based on the payment configurations 410 and/or the cryptocurrency monitoring manager 412. After selecting a decentralize finance platform, the card transaction rerouting system 102 utilizes the API 406 to pull the funds for the transaction from the user account 414 and then deposit the funds in the selected decentralized finance platform. Because the payment configurations 410 and/or the cryptocurrency monitoring manager 412 can change, the aggregator layer 408 may select a different decentralized finance platform for different blockchain transactions for the same merchant system.

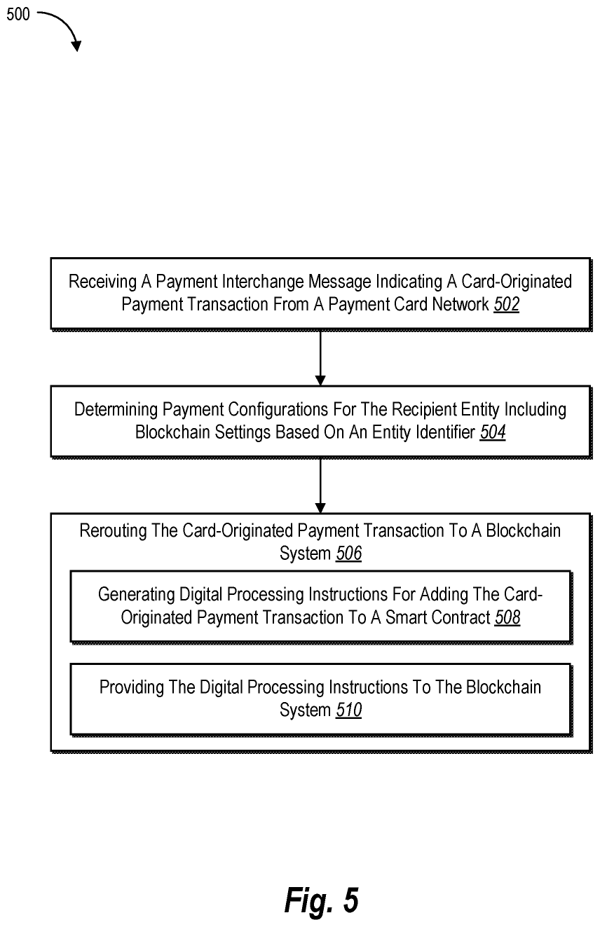

Turning now to FIG. 5, this figure shows a flowchart of a series of acts 500 of rerouting a card-originated payment transaction to a blockchain system. While FIG. 5 illustrates acts according to one embodiment, alternative embodiments may omit, add to, reorder, and/or modify any of the acts shown in FIG. 5. The acts of FIG. 5 can be performed as part of a method. Alternatively, a non-transitory computer readable medium can comprise instructions, that when executed by one or more processors, cause a computing device to perform the acts of FIG. 5. In still further embodiments, a system can perform the acts of FIG. 5.

As shown, the series of acts 500 includes an act 502 of receiving a payment interchange message indicating a card-originated payment transaction from a payment card network. For example, act 502 involves receiving, from a payment card network, a payment interchange message indicating a card-originated payment transaction initiated at a point-of-sale device of a recipient entity, the payment interchange message comprising an entity identifier corresponding to the recipient entity.

The series of acts 500 also includes an act 504 of determining payment configurations for the recipient entity including blockchain settings based on an entity identifier. For example, act 504 involves determining, based on the entity identifier, payment configurations for the recipient entity, wherein the payment configurations comprise blockchain settings for enabling blockchain transactions. Act 504 can involve determining a risk level of the recipient entity, settlement preferences for settling the card-originated payment transaction, and cryptocurrency preferences from the blockchain settings for the recipient entity.

Additionally, the series of acts 500 includes an act 506 of rerouting the card-originated payment transaction to a blockchain system. For example, act 506 involves rerouting, based on the blockchain settings, the card-originated payment transaction from a default payment card network workflow via the payment card network to a blockchain system.

Act 506 can also involve determining a platform preference associated with the recipient entity based on a risk level, the settlement delay time, or a yield preference from the blockchain settings. For example, the yield preference can include a minimum interest rate. Act 506 can then involve selecting, based on the platform preference, the decentralized finance platform from a plurality of decentralized finance platforms for transferring the funds via the blockchain system.

Act 506 also includes an act 508 of generating digital processing instructions for adding the card-originated payment transaction to a smart contract. For example, act 508 involves generating digital processing instructions for adding the card-originated payment transaction to a smart contract within the blockchain system. Act 508 can involve generating digital processing instructions to transfer funds from a cryptocurrency account of a sender user for an amount indicated by the card-originated payment transaction to a decentralized finance platform of the blockchain system.

Act 508 can further involve generating digital processing instructions to delay settlement of the funds by transferring the funds from the decentralized finance platform to a recipient account of the recipient entity according to a settlement delay time determined from the blockchain settings. For example, the settlement delay time can indicate an amount of time funds for the card-originated payment transaction are in the blockchain system. The digital processing instructions can then indicate to transfer the funds from the blockchain system to a recipient account of the recipient entity after the settlement delay time.

Act 508 can also involve generating digital processing instructions to a risk level associated with the recipient entity from the blockchain settings, and determine the settlement delay time further based on the risk level associated with the recipient entity.

Act 508 can also involve generating digital processing instructions to determine a yield amount based on the decentralized finance platform, an amount of time the funds are in the blockchain system, and the amount indicated by the card-originated payment transaction. Accordingly, act 508 can involve determining, based on the blockchain settings, a yield amount in addition to an amount indicated by the card-originated payment transaction. Act 508 can then involve generating digital processing instructions to distribute portions of the yield amount to the payment card network and the recipient account of the recipient entity. Act 508 can thus involve generating digital processing instructions to transfer funds comprising the amount indicated by the card-originated payment transaction and a portion of the yield amount to a recipient account of the recipient entity.

Act 508 can further involve generating digital processing instructions to transfer the funds to the recipient account of the recipient entity in response to meeting one or more thresholds from the blockchain settings. For example, act 508 can involve generating digital processing instructions to transfer funds from a cryptocurrency account of a sender user to a decentralized finance platform of the blockchain system based on the card-originated payment transaction. Act 508 can further involve generating digital processing instructions to transfer the funds and an additional yield amount to a recipient account of the recipient entity after a settlement delay time based on the blockchain settings.

In one or more embodiments, act 506 involves generating, via an authorization layer of an application programming interface and based on the blockchain settings, an authorization request to authorize the card-originated payment transaction with a cryptocurrency exchange platform associated with a cryptocurrency account of a sender user. For example, act 506 can involve authorizing the card-originated payment transaction with a cryptocurrency exchange platform associated with a sender user by utilizing an authorization layer of an application programming interface. Act 508 can involve selecting a decentralized finance platform from a plurality of decentralized finance platforms by utilizing an aggregator layer of the application programming interface. Act 508 can then involve generating the digital processing instructions in response to receiving authorization from the cryptocurrency exchange platform. For example, act 508 can involve generating the digital processing instructions to reroute, based on the blockchain settings, the card-originated payment transaction by utilizing a service layer of the application programming interface. Act 508 can further involve generating the smart contract to include the digital processing instructions.

Act 506 also includes an act 510 of providing the digital processing instructions to the blockchain system. For example, act 510 involves providing the digital processing instructions to the blockchain system to add the card-originated payment transaction to the smart contract. Act 510 can involve generating the smart contract to provide to the blockchain system. Act 510 can then involve deploying the smart contract comprising the digital processing instructions to the blockchain system.

In one or more embodiments, the series of acts 500 also includes generating a notification comprising the settlement delay time based on the blockchain settings. Additionally, the series of acts 500 can include providing the notification indicating the settlement delay time to the payment card network in response to determining that the payment configurations comprise the blockchain settings for enabling blockchain transactions.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the system(s) of FIG. 1. As shown by FIG. 6, the computing device 600 can comprise a processor 602, a memory 604, a storage device 606, an I/O interface 608, and a communication interface 610, which may be communicatively coupled by way of a communication infrastructure 612. In certain embodiments, the computing device 600 can include fewer or more components than those shown in FIG. 6. Components of the computing device 600 shown in FIG. 6 will now be described in additional detail.

In one or more embodiments, the processor 602 includes hardware for executing instructions, such as those making up a computer program. As an example, and not by way of limitation, to execute instructions for dynamically modifying workflows, the processor 602 may retrieve (or fetch) the instructions from an internal register, an internal cache, the memory 604, or the storage device 606 and decode and execute them. The memory 604 may be a volatile or non-volatile memory used for storing data, metadata, and programs for execution by the processor(s). The storage device 606 includes storage, such as a hard disk, flash disk drive, or other digital storage device, for storing data or instructions for performing the methods described herein.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example, and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 610 may facilitate communications with various types of wired or wireless networks. The communication interface 610 may also facilitate communications using various communication protocols. The communication infrastructure 612 may also include hardware, software, or both that couples components of the computing device 600 to each other. For example, the communication interface 610 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

1. A computer-implemented method comprising:
receiving, by one or more servers of a card transaction rerouting system from a payment card network, a payment interchange message indicating a card-originated payment transaction initiated at a point-of-sale device of a recipient entity, the payment interchange message comprising an entity identifier corresponding to the recipient entity and the point-of-sale device separate from the card transaction rerouting system;
determining, by the one or more servers of the card transaction rerouting system and based on the entity identifier, payment configurations stored at the one or more servers of the card transaction rerouting system for the recipient entity, wherein the payment configurations comprise blockchain settings for enabling blockchain transactions; and
rerouting, by the one or more servers of the card transaction rerouting system and based on the blockchain settings, the card-originated payment transaction from a default payment card network workflow via the payment card network to a blockchain system by:
generating, by the one or more servers of the card transaction rerouting system, digital processing instructions for adding the card-originated payment transaction to a smart contract within the blockchain system; and
providing, by the one or more servers of the card transaction rerouting system, the digital processing instructions to the blockchain system to add the card-originated payment transaction to the smart contract.

2. The computer-implemented method as recited in claim 1, wherein determining the payment configurations comprises determining a risk level of the recipient entity, settlement preferences for settling the card-originated payment transaction, and cryptocurrency preferences from the blockchain settings for the recipient entity.

3. The computer-implemented method as recited in claim 1, wherein generating the digital processing instructions comprises generating digital processing instructions to transfer funds from a cryptocurrency account of a sender user for an amount indicated by the card-originated payment transaction to a decentralized finance platform of the blockchain system.

4. The computer-implemented method as recited in claim 3, wherein generating the digital processing instructions comprises generating digital processing instructions to delay settlement of the funds by transferring the funds from the decentralized finance platform to a recipient account of the recipient entity according to a settlement delay time determined from the blockchain settings.

5. The computer-implemented method as recited in claim 4, wherein generating the digital processing instructions comprises generating digital processing instructions to:
determine a risk level associated with the recipient entity from the blockchain settings; and
determine the settlement delay time further based on the risk level associated with the recipient entity.

6. The computer-implemented method as recited in claim 4, further comprising:
generating a notification comprising the settlement delay time based on the blockchain settings; and
providing the notification indicating the settlement delay time to the payment card network in response to determining that the payment configurations comprise the blockchain settings for enabling blockchain transactions.

7. The computer-implemented method as recited in claim 4, wherein rerouting the card-originated payment transaction further comprises:
determining a platform preference associated with the recipient entity based on a risk level, the settlement delay time, or a yield preference from the blockchain settings; and
selecting, based on the platform preference, the decentralized finance platform from a plurality of decentralized finance platforms for transferring the funds via the blockchain system.

8. The computer-implemented method as recited in claim 4, wherein generating the digital processing instructions comprises generating digital processing instructions to:
determine a yield amount based on the decentralized finance platform, an amount of time the funds are in the blockchain system, and the amount indicated by the card-originated payment transaction; and
distribute portions of the yield amount to the payment card network and the recipient account of the recipient entity.

9. The computer-implemented method as recited in claim 1, wherein generating the digital processing instructions comprises:
generating the digital processing instructions utilizing a service layer of an application programming interface of the card transaction rerouting system;
generating the smart contract to include the digital processing instructions; and
deploying the smart contract comprising the digital processing instructions to the blockchain system.

10. The computer-implemented method as recited in claim 1, wherein rerouting the card-originated payment transaction further comprises:
generating, via an authorization layer of an application programming interface of the card transaction rerouting system and based on the blockchain settings, an authorization request to authorize the card-originated payment transaction with a cryptocurrency exchange platform associated with a cryptocurrency account of a sender user; and
generating the digital processing instructions in response to receiving authorization from the cryptocurrency exchange platform.

11. A system comprising:
at least one processor; and
a non-transitory computer readable storage medium comprising instructions that, when executed by at least one processor, cause the system to:
receive, by a card transaction rerouting system from a payment card network, a payment interchange message indicating a card-originated payment transaction initiated at a point-of-sale device of a recipient entity, the payment interchange message comprising an entity identifier corresponding to the recipient entity and the point-of-sale device separate from the card transaction rerouting system;
determine, by the card transaction rerouting system and based on the entity identifier, payment configurations for the recipient entity stored at one or more servers of the card transaction rerouting system, wherein the payment configurations comprise blockchain settings for enabling blockchain transactions; and
reroute, by the card transaction rerouting system and based on the blockchain settings, the card-originated payment transaction from a default payment card network workflow via the payment card network to a blockchain system by:
generating, by the card transaction rerouting system, digital processing instructions for adding the card-originated payment transaction to a smart contract within the blockchain system; and
providing, by the card transaction rerouting system, the digital processing instructions to the blockchain system to add the card-originated payment transaction to the smart contract.

12. The system as recited in claim 11, further comprising instructions that, when executed by the at least one processor, cause the system to generate the digital processing instructions by:
selecting a decentralized finance platform from a plurality of decentralized finance platforms based on the blockchain settings; and
generating digital processing instructions to transfer funds from a cryptocurrency account of a sender user to the decentralized finance platform.

13. The system as recited in claim 11, further comprising instructions that, when executed by the at least one processor, cause the system to:
determine the payment configurations for the recipient entity by determining a risk level of the recipient entity, settlement preferences for settling the card-originated payment transaction, and cryptocurrency preferences from the blockchain settings for the recipient entity; and
generate the digital processing instructions to add the card-originated payment transaction to the smart contract according to the risk level, the settlement preferences, and the cryptocurrency preferences.

14. The system as recited in claim 11, further comprising instructions that, when executed by the at least one processor, cause the system to:
determine, based on the blockchain settings, a settlement delay time indicating an amount of time funds for the card-originated payment transaction are in the blockchain system; and
generate the digital processing instructions further to transfer the funds from the blockchain system to a recipient account of the recipient entity after the settlement delay time.

15. The system as recited in claim 11, further comprising instructions that, when executed by the at least one processor, cause the system to:
determine, based on the blockchain settings, a yield amount in addition to an amount indicated by the card-originated payment transaction; and
generate the digital processing instructions to transfer funds comprising the amount indicated by the card-originated payment transaction and a portion of the yield amount to a recipient account of the recipient entity.

16. The system as recited in claim 15, further comprising instructions that, when executed by the at least one processor, cause the system to generate the digital processing instructions to transfer the funds to the recipient account of the recipient entity in response to meeting one or more thresholds from the blockchain settings.

17. A non-transitory computer readable storage medium comprising instructions that, when executed by at least one processor, cause a computing device to:
receive, by a card transaction rerouting system from a payment card network, a payment interchange message indicating a card-originated payment transaction initiated at a point-of-sale device of a recipient entity, the payment interchange message comprising an entity identifier corresponding to the recipient entity and the point-of-sale device separate from the card transaction rerouting system;
determine, by the card transaction rerouting system and based on the entity identifier, payment configurations for the recipient entity stored at one or more servers of the card transaction rerouting system, wherein the payment configurations comprise blockchain settings for enabling blockchain transactions; and
reroute, by the card transaction rerouting system and based on the blockchain settings, the card-originated payment transaction from a default payment card network workflow via the payment card network to a blockchain system by:
generating, by the card transaction rerouting system, digital processing instructions for adding the card-originated payment transaction to a smart contract within the blockchain system; and
providing, by the card transaction rerouting system, the digital processing instructions to the blockchain system to add the card-originated payment transaction to the smart contract.

18. The non-transitory computer readable storage medium as recited in claim 17, further comprising instructions that, when executed by the at least one processor, cause the computing device to determine the payment configurations by determining settlement preferences for settling the card-originated payment transaction based on a settlement delay time and an interest rate from the blockchain settings.

19. The non-transitory computer readable storage medium as recited in claim 17, further comprising instructions that, when executed by the at least one processor, cause the computing device to:
authorize the card-originated payment transaction with a cryptocurrency exchange platform associated with a sender user by utilizing an authorization layer of an application programming interface of the card transaction rerouting system;
select a decentralized finance platform from a plurality of decentralized finance platforms by utilizing an aggregator layer of the application programming interface; and
generate the digital processing instructions to reroute, based on the blockchain settings, the card-originated payment transaction by utilizing a service layer of the application programming interface.

20. The non-transitory computer readable storage medium as recited in claim 17, further comprising instructions that, when executed by the at least one processor, cause the computing device to generate the digital processing instructions to:
transfer funds from a cryptocurrency account of a sender user to a decentralized finance platform of the blockchain system based on the card-originated payment transaction; and
transfer the funds and an additional yield amount to a recipient account of the recipient entity after a settlement delay time based on the blockchain settings.
